(19) United States
(12) Patent Application Publication
(10) Pub. No.: US 2012/0160090 A1
(43) Pub. Date: Jun. 28, 2012

(54) AIR CYLINDER

(75) Inventors: Akiyoshi Kato, Tsukubamirai-shi (JP); Naoki Shinjo, Tsukubamirai-shi (JP)

(73) Assignee: SMC CORPORATION, Tokyo (JP)

(21) Appl. No.: 13/394,236

(22) PCT Filed: Mar. 9, 2010
(86) PCT No.: PCT/JP2010/053849

§ 371 Date: Mar. 5, 2012

(30) Foreign Application Priority Data
Sep. 9, 2009 (JP) 2009-208522

(51) Int. Cl. F15B 15/14; F01B 31/00; F01B 31/10

(52) U.S. Cl. 92/87; 92/153; 92/163

(57) ABSTRACT

An air cylinder that can prevent foreign substances from intruding inside in an environment where fine foreign substances such as dust are scattered. The air cylinder includes, in a through hole of a rod cover, an annular lubricator impregnated with a lubricant so as to supply the lubricant to the rod and a liquid-absorptive annular dust wiper not containing a lubricant and provided for preventing fine foreign substances such as powder stuck to the rod from intruding inside. The lubricator and the dust wiper are disposed air-tightly and slidably in contact with the rod, and the dust wiper is located closer to a leading end of the rod than the lubricator.

### TECHNICAL FIELD

The present invention relates to an air cylinder, and more particularly to an air cylinder suitable for use in an environment where fine foreign substances such as dust are scattered.

### BACKGROUND ART

The air cylinder has conventionally been widely employed, for example, as an actuator of various automatic machines, and generally includes a piston to which a rod is fixed, the piston being configured so as to reciprocate in a cylinder chamber, a rod cover provided on an end portion of the cylinder and including a through hole that slidably supports the rod, and a seal member that maintains air-tightness inside the through hole between the through hole and the rod.

Regarding the air cylinder thus configured, it is a known practice to provide, inside the through hole, a lubricator that supplies a lubricant to the rod and a dust wiper that prevents a fine foreign substance such as dust stuck to the rod from intruding inside.

As an example of the air cylinder provided with the lubricator and the dust wiper, Patent Document 1 discloses a structure in which a dust seal 19 is attached to a rod cover 11 at a position close to a gateway of a piston rod 2, and a solid lubricant 15 constituted of an oil-impregnated felt or the like is provided closer to the piston than the dust seal 19, so as to slidably contact the piston rod 2. In addition, Patent Document 2 discloses an air cylinder that includes an annular rubber scraper 36 and an impregnated material 41 provided in a rod insertion hole 30 of a rod cover 16, the impregnated material 41 containing a mixture of an anti-spatter agent and a lubricant.

However, in the air cylinder according to PTL 1 and PTL 2, the lubricant supplied to the rod by the solid lubricant 15 or the impregnated material 41 is prone to leak beyond the dust seal 19 or the rubber scraper 36 serving as the dust wiper, with the forward strokes of the rod. Accordingly, foreign substances are induced to stick to the rod, and moreover foreign substances collected by the dust wiper may absorb the lubricant and be deposited on the surface of the rod. With continued use of the air cylinder under such a condition, the foreign substances may intrude inside the air cylinder past the dust wiper and cause damage to the seal member, and therefore the foreign substances have to be frequently removed from the rod.

### PRIOR ART DOCUMENT

### Patent Document

Patent Document 1: Japanese Unexamined Patent Application Publication No. 49-20581
Patent Document 2: Japanese Patent No. 3786620

### SUMMARY OF INVENTION

### Technical Problem

Accordingly, an object of the present invention is to provide an air cylinder that can surely prevent a foreign substance from intruding inside, in an environment where fine foreign substances such as dust are scattered.

### Solution to Problem

To achieve the foregoing object, the present invention provides an air cylinder including a piston that reciprocates in an axial direction of a cylinder chamber by supply and discharge of compressed air, a rod attached to the piston so as to extend in the axial direction and to reciprocate together with the piston, a rod cover provided on an end portion of the cylinder chamber in the axial direction and including a through hole that slidably supports the rod penetrating therethrough, and an annular seal member provided in the through hole so as to air-tightly and slidably contact the rod. The rod cover includes a first end and a second end in the axial direction, the first end being located on the side of the cylinder chamber and the second end being located opposite the first end, and the through hole is formed through the rod cover between the first end and the second end. The through hole includes an annular lubricator impregnated with a lubricant so as to supply the lubricant to the rod and a liquid-absorptive annular dust wiper not containing a lubricant and provided for preventing a foreign substance stuck to the rod from intruding into the first end side, the lubricator and the dust wiper being disposed in slidably contact with the rod. The lubricator is located closer to the second end than the seal member is, and the dust wiper is located closer to the second end than the lubricator is.

In the air cylinder according to the invention, the lubricator and the dust wiper may be spaced from each other in the axial direction by an interval shorter than a stroke length of the piston, and the dust wiper may be located close to an opening formed in the second end of the through hole.

The dust wiper may be formed of a dry porous material having flexibility and compressibility, in which inner pores communicate with each other. Preferably, the dust wiper may be larger in volume than the lubricator, and more preferably the porous material may be an aggregate fibrous material formed by combining fibers together.

In an embodiment of the present invention, the dust wiper is breathable, and the through hole includes an air inlet for air purge formed between the dust wiper and the lubricator.

In another embodiment, a non-porous annular scraper is provided adjacent to the dust wiper on the side of the first end so as to slidably contact the rod, and a surface of the scraper oriented to the second end and a surface of the dust wiper oriented to the first end are in close contact with each other. In this case, it is preferable that the scraper includes an acute-angle portion directed toward the second end, such that the scraper is in contact with the rod via the acute-angle portion.

Further, the air cylinder may include a fitting groove that accommodates therein the dust wiper formed on an inner circumferential surface of the through hole so as to open at the second end of the rod cover, and the dust wiper may be introduced in the fitting groove through the opening thereof at the second end, so as to be fitted in the fitting groove by providing a fixing member from the second end side so as to abut the dust wiper. The fixing member may be detachably attached to the fitting groove in the axial direction, so that the dust wiper can be replaced through the opening at the second end by detaching and attaching the fixing member.

### Advantageous Effects of Invention

With the air cylinder according to the present invention, the dust wiper is liquid-absorptive, and hence not only scrapes off foreign substances from outside but also absorbs the lubricant. Such a configuration effectively suppresses the lubricant from leaking out beyond the dust wiper, thereby preventing foreign substances from sticking to the surface of the rod and foreign substances scraped off by the dust wiper from being deposited, thus further assuring prevention of intrusion of foreign substances inside the air cylinder.

In addition, the dust wiper formed of a dry porous material in which inner pores communicate with each other is capable of entrapping therein fine foreign substances such as powder, which further assures that foreign substances scraped off by the dust wiper be prevented from being deposited on the rod.

### BRIEF DESCRIPTION OF DRAWINGS

FIG. 1 is a schematic cross-sectional view of an air cylinder according to a first embodiment of the present invention.

FIG. 2 is a schematic fragmentary cross-sectional view of an air cylinder according to a second embodiment of the present invention.

FIG. 3 is a schematic fragmentary cross-sectional view of an air cylinder according to a third embodiment of the present invention.

FIG. 4 is a schematic front view of a dust wiper employed in the third embodiment.

FIG. 5 is a schematic left side view of the dust wiper shown in FIG. 3.

FIG. 6 is a schematic fragmentary cross-sectional view of an air cylinder according to a fourth embodiment of the present invention.

### EXPLANATION OF REFERENCE

1, 20, 30, 40 AIR CYLINDER
2 CYLINDER CHAMBER
3 CYLINDER BODY
4 PISTON
5 ROD
6 THROUGH HOLE
6a FIRST FITTING GROOVE
6b SECOND FITTING GROOVE
6c, 36, 46 THIRD FITTING GROOVE
36a, 46a OPENING IN SECOND END OF THIRD FITTING GROOVE
46b MAJOR DIAMETER PORTION
46c MINOR DIAMETER PORTION
7 ROD COVER
7a FIRST END
7b SECOND END
7c FIRST PORTION
7d SECOND PORTION
8 HEAD COVER
9 SEAL MEMBER
10 LUBRICATOR
11, 33, 44 DUST WIPER
33a CUT LINE
44a FIRST SLOPED SURFACE
12 OPENING IN SECOND END OF THROUGH HOLE
21 AIR INLET
32 SCREW HOLE
32 FIXING SCREW
32a MALE-THREADED PORTION
32b SCREW HEAD
34 FIXING RING (FIXING MEMBER)
45 SCRAPER
45a ACUTE-ANGLE PORTION
45b SECOND SLOPED SURFACE
45c INNER CIRCUMFERENTIAL SURFACE

### DESCRIPTION OF EMBODIMENTS

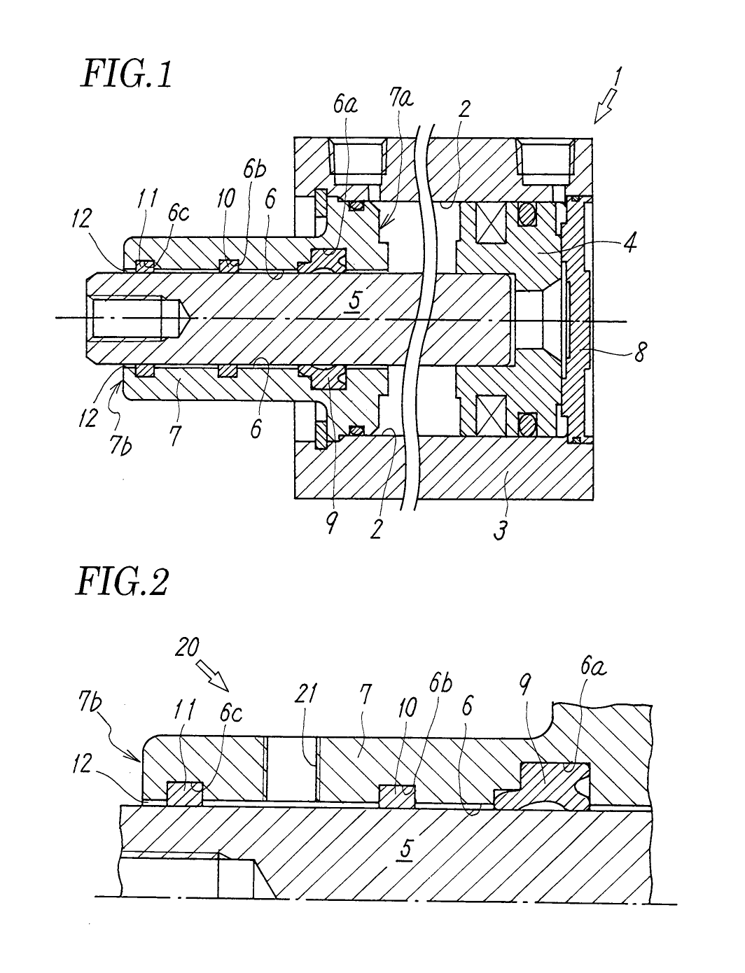

FIG. 1 shows a first embodiment of an air cylinder according to the present invention.

As shown in FIG. 1, the air cylinder 1 includes a cylinder body 3 of a cylindrical shape with both ends opened and including therein a cylinder chamber 2 extending in an axial direction, a piston 4 that reciprocates in the cylinder chamber 2 in the axial direction by supplying and discharging compressed air to and from the cylinder chamber 2, a rod 5 having a base portion thereof fixed to the piston 4 and disposed so as to extend in the axial direction in the cylinder chamber 2, a rod cover 7 provided on an end portion of the cylinder chamber 2 in the axial direction so as to air-tightly close one of the openings of the cylinder body 3, and including a through hole 6 that allows the rod 5 to penetrate therethrough to air-tightly support the rod 5 so as to slidingly reciprocate and allows the rod 5 to stick out of the air cylinder 1, and a head cover 8 provided on the other end portion of the cylinder chamber 2 in the axial direction so as to air-tightly close the other opening of the cylinder body 3.

The rod cover 7 includes, in the axial direction, a first end 7a located on the side of the cylinder chamber 2 (more specifically, facing the cylinder chamber 2), and a second end 7b located opposite the first end 7a in the axial direction (more specifically, exposed outside the air cylinder 1). The through hole 6 is formed between the first end 7a and the second end 7b. Although the rod cover 7 is formed as a single piece in this embodiment, the rod cover 7 may be composed of a plurality of members.

A lip-shaped annular seal member 9 formed of an elastic material such as rubber is provided in the through hole 6 at a position close to the first end 7a, such that an outer circumferential portion of the seal member 9 is fitted in a first annular fitting groove 6a, and an inner circumferential portion thereof is disposed air-tightly and slidably in contact with an outer circumferential surface of the rod 5. Such a structure allows the rod 5 to move forward to outside of the air cylinder 1 and backward into the cylinder chamber 2 interlocked with the reciprocating action of the piston 4, maintaining the air-tightness between the through hole 6 and the rod 5.

An annular lubricator 10 and an annular dust wiper 11 are provided in the through hole 6 at positions closer to the second end 7b than the annular seal member 9 is. The lubricator 10 is formed of a porous material having flexibility and compressibility, in which inner pores communicate with each other, and impregnated with a lubricant such as oil or grease. The lubricator 10 has an annular shape having a generally rectangular cross-section. In contrast, the dust wiper 11 is formed of the same porous material and in the same shape and size as the lubricator 10, but provided in a dry state without being impregnated with the lubricant, and hence highly liquid-absorptive.

A typical example of the porous material is a non-woven aggregate fibrous material (for example, felt) formed by interlacing or bonding fibers such as wool or a synthetic fiber (preferably a crimping composite fiber) thereby combining the fibers. In particular, a material formed by combining a synthetic fiber such as polyester fiber with an elastic material such as rubber is preferably employed.

Here, the lubricator 10 and the dust wiper 11 may be respectively formed of different materials, and may be different in diameter, cross-sectional shape, or cross-sectional area.

The lubricator 10 and the dust wiper 11 are located in the through hole 6 with an interval therebetween in the axial direction. More specifically, the lubricator 10 is located closer to the second end 7b than the annular seal member 9, with an interval therebetween shorter than the stroke length of the piston 4. The dust wiper 11 is located closer to the second end 7b than the lubricator 10 with an interval therebetween shorter than the stroke length of the piston 4, and at a position close to an opening 12 of the through hole 6 formed in the second end 7b.

Further, the lubricator 10 and the dust wiper 11 have the outer circumferential portion fitted in a second annular fitting groove 6b and a third annular fitting groove 6c formed in the through hole 6, respectively, and the inner circumferential surface disposed slidably in press-contact with the outer circumferential surface of the rod 5. In addition, the respective surfaces of the dust wiper 11 oriented to the first end 7a and the second end 7b are generally perpendicular to the outer circumferential surface of the rod 5.

Accordingly, when the rod 5 moves forward or backward, the lubricant exudes out of the lubricator 10 thus to be applied to the outer circumferential surface of the rod 5, thereby allowing the rod 5 to smoothly reciprocate. In contrast, the dust wiper 11 scrapes off, when the rod 5 moves backward, fine foreign substances (for example, fine powder of a toner or resin that may cause, upon intruding inside the air cylinder 1, an increase in frictional resistance, wear of parts, and acceleration of corrosion which leads to functional degradation or reduction of life span of the air cylinder 1) stuck to the outer circumferential surface of the rod 5. The dust wiper 11 thus prevents the foreign substances stuck to the rod 5 from intruding past the dust wiper 11, from outside of the air cylinder 1 toward the first end 7a.

The lubricant supplied from the lubricator 10 is, as stated above, applied to the outer circumferential surface of the rod 5 in the axial direction with the reciprocating motion thereof. In this relation, since the dust wiper 11 is highly liquid-absorptive, in addition to being capable of preventing the external foreign substances from intruding into the air cylinder 1, the dust wiper 11 can also suppress the lubricant from leaking out beyond the dust wiper 11. Accordingly, foreign substances are less likely to be caught by the lubricant so as to stick to the surface of the rod 5 and foreign substances scraped off by the dust wiper 11 are less likely to be deposited, and thus the foreign substances are induced to spontaneously come off from the surface of the rod 5. Consequently, foreign substances on the rod 5 can be more securely prevented from intruding inside the air cylinder 1 beyond the dust wiper 11.

In addition, the dust wiper 11 is formed of a dry porous material in which inner pores communicate with each other and is hence capable of entrapping therein fine foreign substances such as powder as stated above. Such a structure further assures that foreign substances scraped off be prevented from being deposited on the rod 5.

Further, the lubricant thus absorbed by the dust wiper 11 may be supplied again to the outer circumferential surface of the rod 5.

Thus, the air cylinder 1 more securely prevents, compared with conventional ones, foreign substances from intruding inside the air cylinder 1, and also prevents the lubricant from being removed together with the foreign substances because of frequent maintenance works, thereby allowing securing and maintaining high lubricating performance for the rod 5 over a prolonged period of time. Consequently, the maintenance interval for the air cylinder 1, as well as the life span of the air cylinder 1 can be extended.

Referring now to FIG. 2, a second embodiment of the present invention will be described. In order to avoid duplicated description, the same constituents as those of the first embodiment will be given the same numeral, and the description thereof and of the advantageous effects thereby obtained will not be repeated.

An air cylinder 20 according to this embodiment is configured so as to introduce compressed air into the through hole 6 and utilize the compressed air as purging air, to thereby blowing foreign substances on the rod 5 and foreign substances entrapped by the dust wiper 11 out of the air cylinder 20 thus removing those foreign substances.

More specifically, the rod cover 7 includes an air inlet 21 formed in the through hole 6 for introducing the compressed air into the through hole 6. The air inlet 21 is formed generally perpendicular to the outer circumferential surface of the rod 5, at a position between the lubricator 10 and the dust wiper 11 in the axial direction of the through hole 6. The air inlet 21 is connected to a pressure source (not shown), so that once the compressed air from the pressure source is introduced into the through hole 6 through the air inlet 21 the compressed air flows toward the opening 12 of the rod cover 7, through a gap formed between the through hole 6 and the rod 5.

In this embodiment also, the dust wiper 11 is formed of the same porous material as that employed in the first embodiment, which is breathable because the dust wiper 11 is dry and the inner pores communicate with each other, and hence the compressed air can flow toward the opening 12 past the dust wiper 11. Accordingly, the compressed air blows foreign substances on the outer circumferential surface of the rod 5 out of the air cylinder 20 upon passing through the dust wiper 11 and being discharged to the atmosphere, thereby forcibly removing foreign substances from the rod 5. In addition, foreign substances entrapped inside the dust wiper 11 can also be forcibly discharged to outside of the air cylinder 20 by the compressed air, and therefore the dust wiper 11 can be prevented from clogging.

Thus, the air cylinder 20 according to this embodiment is configured so as to introduce compressed air into the through hole 6 and discharge the air through the opening 12, and can therefore forcibly remove foreign substances on the rod 5 and foreign substance entrapped by the dust wiper 11. Such a configuration further assures prevention of foreign substances from intruding inside the air cylinder 20, and also minimizes the trouble of the maintenance work such as cleaning or washing.

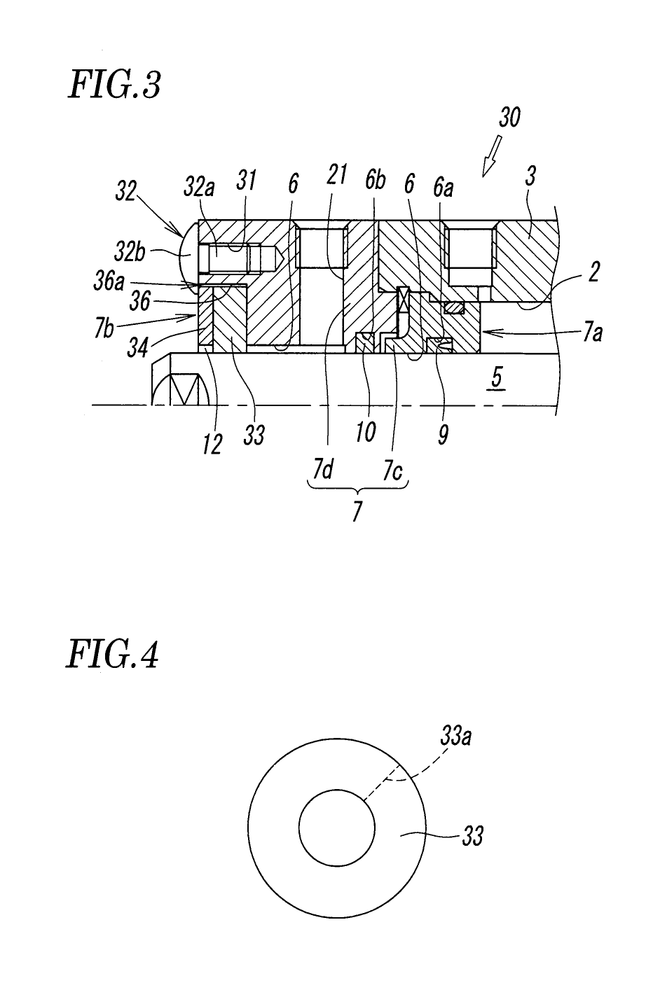

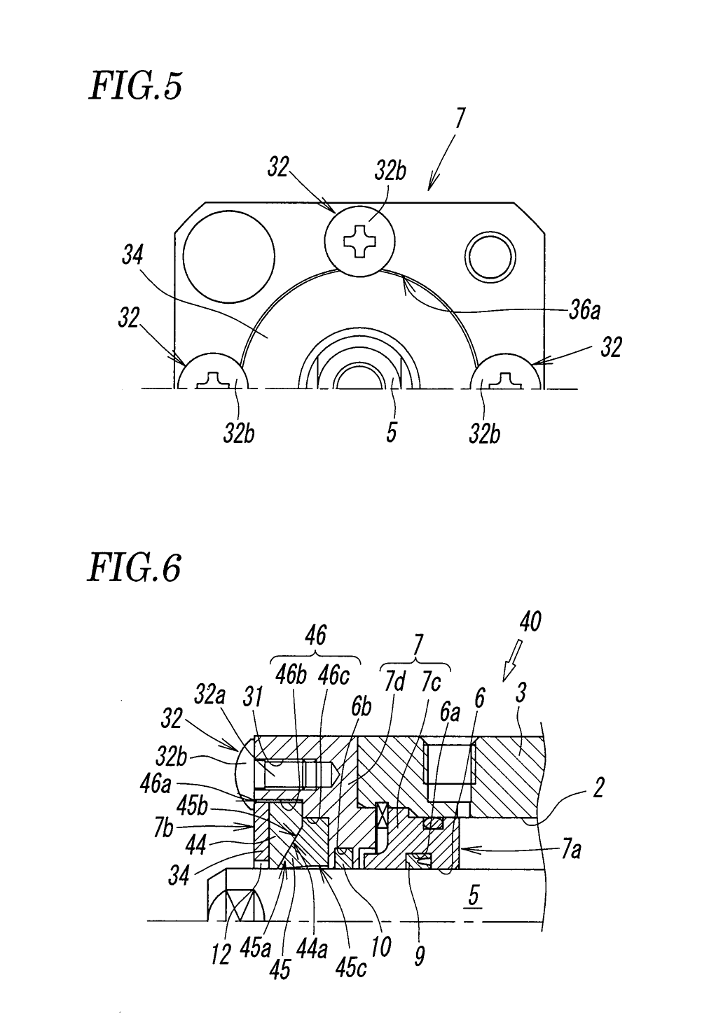

Hereafter, a third embodiment of the present invention will be described referring to FIGS. 3 to 5. In order to avoid duplicated description, the same constituents as those of the first and the second embodiment will be given the same numeral, and the description thereof and of the advantageous effects thereby obtained will not be repeated.

In an air cylinder 30 according to this embodiment, the rod cover 7 is composed of a first portion 7c located on the side of the cylinder chamber 2 and a second portion 7d located on the side of the leading end of the rod 5, coupled together in the axial direction. A surface of the first portion 7c facing the cylinder chamber 2 constitutes the first end 7a, and a surface of the second portion 7d exposed to outside of the air cylinder 30 constitutes the second end 7b.

The lip-shaped annular seal member 9 formed of an elastic material such as rubber is provided in the first annular fitting groove 6a formed in the through hole 6 of the first portion 7c, such that the outer circumferential portion of the seal member 9 is fitted in the first annular fitting groove 6a, and the inner circumferential portion thereof is disposed air-tightly and slidably in contact with the outer circumferential surface of the rod 5.

The annular lubricator 10 is attached to the through hole 6 in the second portion 7d, with the outer circumferential portion fitted in the second annular fitting groove 6b and the inner circumferential surface disposed slidably in press-contact with the outer circumferential surface of the rod 5, and also an annular dust wiper 33 is attached with the outer circumferential portion fitted in a third annular fitting groove 36 and the inner circumferential surface disposed slidably in press-contact with the outer circumferential surface of the rod 5, at a position closer to the second end 7b than the lubricator 10.

The dust wiper 33 is formed of the same porous material as that employed in the foregoing embodiments in an annular shape having a generally rectangular cross-section, and an inner diameter generally the same as that of the lubricator 10. However, the dust wiper 33 is longer in axial direction and larger in outer diameter than the lubricator 10, i.e., larger in volume than the lubricator 10.

In this embodiment, the third fitting groove 36 is open not only in the inner circumferential surface of the through hole 6 but also in the second end 7b of the rod cover 7, and the dust wiper 33 and a fixing ring 34 that retains the dust wiper 33 in the third fitting groove 36 are accommodated adjacent to each other in the axial direction in the third fitting groove 36, through an opening 36a of the second end 7b. The dust wiper 33 is fixed in the third fitting groove 36 upon being abutted by the fixing ring 34 from the side of the second end 7b. In this case, the fixing ring 34 is attached to the third fitting groove 36 so as to be removed in the axial direction, so that upon removing the fixing ring 34 the dust wiper 33 can be replaced through the opening 36a.

More specifically, the fixing ring 34 is located closer to the second end 7b than the dust wiper 33, and has an annular plate shape having a generally rectangular cross-section and a generally uniform thickness both in radial and circumferential directions. The fixing ring 34 is generally the same in outer diameter as the dust wiper 33, but larger in inner diameter than the dust wiper 33. Accordingly, the inner circumferential portion of the dust wiper 33 communicates with the atmosphere through a gap formed between the outer circumferential surface of the rod 5 and the inner circumferential surface of the fixing ring 34, and through the opening 12. Further, the inner circumferential surface of the third fitting groove 36 has a slightly larger diameter than the outer diameter of the dust wiper 33 and the fixing ring 34. Accordingly, a gap having an opening in the second end 7b of the rod cover 7 is formed between the inner circumferential surface of the third fitting groove 36 and the outer circumferential surface of the dust wiper 33 and the fixing ring 34, so that the outer circumferential portion of the dust wiper 33 communicates with the atmosphere through the gap and the opening 36a of the second end 7b. Here, the third fitting groove 36 has an axial length that is equal to or slightly shorter than the total axial length of the dust wiper 33 and the fixing ring 34.

A plurality of screw holes 31 (in this embodiment, four holes at every 90 degrees) with a female thread formed on the inner wall is provided in the second end 7b around the third fitting groove 36, and a fixing screw 32, including a male-threaded portion 32a having a male thread formed on the outer circumferential surface and a screw head 32b larger in diameter than the male-threaded portion 32a, is detachably screw-fitted in each screw hole 31. Upon screw-fitting and fastening the fixing screw 32 in the screw hole 31, the outer peripheral portion of the screw head 32b of the fixing screw 32 is engaged with the peripheral portion of the surface of the fixing ring 34 on the side of the second end 7b, so that the dust wiper 33 can be retained between the fixing ring 34 and the sidewall of the third fitting groove 36. Here, since the total axial length of the dust wiper 33 and the fixing ring 34 is slightly longer than the axial length of the third fitting groove 36 as stated above, the dust wiper 33 can be retained by being compressed to such an extent that the performance thereof is exempted from being affected, and thus the dust wiper 33 can be securely fixed to the fitting groove 36.

Conversely, upon loosening the fixing screw 32 and removing the fixing ring 34 from the fitting groove 36 in the axial direction, the dust wiper 33 can be removed from the fitting groove 36 in the axial direction through the leading end of the rod 5. In this case, providing a cut line 33a in the dust wiper 33 between the inner edge and the outer edge as indicated by broken lines in FIG. 4 allows the dust wiper 33 to be removed from the rod 5 halfway thereof in a lateral direction (orthogonal to the axial direction), despite a work being attached to the leading end of the rod 5, thereby further improving the efficiency in maintenance work.

Thus, in the air cylinder 30 according to this embodiment the dust wiper 33 is formed of the porous material in a sufficiently large volume and hence capable of entrapping a larger amount of fine foreign substances such as powder, and can therefore even more securely prevent foreign substances from being deposited on the outer circumferential surface of the rod 5 or intruding inside the air cylinder 1. In addition, as in the second embodiment, providing the air inlet 21 for air purge in the through hole 6 at a position between the lubricator 10 and the dust wiper 33 allows foreign substances on the outer circumferential surface of the rod 5 and foreign substances entrapped by the dust wiper 33 to be blown away thus to be removed. In this case, allowing each of the inner circumferential portion and the outer circumferential portion of the dust wiper 33 to communicate with the atmosphere as stated above enables the breathability of the dust wiper 33 in a radial direction to be secured, thereby improving not only the removal efficiency of foreign substances by air purge but also entrapment efficiency of foreign substances.

Referring now to FIG. 6, a fourth embodiment of the present invention will be described. In order to avoid duplicated description, the same constituents as those of the first, the second, and the third embodiment will be given the same numeral, and the description thereof and of the advantageous effects thereby obtained will not be repeated.

An air cylinder 40 according to this embodiment also includes an annular dust wiper 44 at a position closer to the second end 7b than the annular lubricator 10, such that the outer circumferential portion of the annular dust wiper 44 is fitted in a third annular fitting groove 46 and the inner circumferential surface thereof is disposed slidably in contact with the outer circumferential surface of the rod 5. In this embodiment, further, an annular scraper 45 having an acute-angle portion 45a directed to the second end 7b, i.e., to the leading end of the rod 5, is attached with the outer circumferential portion fitted in the third fitting groove 46 and the acute-angle portion 45a disposed slidably in contact with the outer circumferential surface of the rod 5 and in close contact with the surface of the dust wiper 44 oriented to the first end 7a.

More specifically, first, the dust wiper 44 is formed of the same porous material as that employed as the dust wiper 33 according to the third embodiment, in an annular shape having a pentagonal cross-section and in a volume larger than that of the lubricator 10. The dust wiper 44 is formed such that the inner circumferential surface and the outer circumferential surface are parallel to the axial line, and the surface oriented to the second end 7b is perpendicular to the axial line. Further, while an outer peripheral portion of the surface of the dust wiper 44 oriented to the first end 7a is perpendicular to the axial line, an inner portion extending from the outer peripheral portion constitutes a first sloped surface 44a inclined toward the second end 7b.

On the other hand, the scraper 45 is formed, unlike the dust wiper 44, of a harder non-porous elastic material such as rubber which is neither liquid-absorptive nor breathable and hence unable to entrap foreign substances, and has an outer diameter smaller than that of the dust wiper 44. The entire outer circumferential surface of the scraper 45 is parallel to the axial line and the entire surface thereof oriented to the first end 7a is perpendicular to the axial line. Further, while an outer peripheral portion of the surface of the scraper 45 oriented to the second end 7b is perpendicular to the axial line, an inner portion extending from the outer peripheral portion constitutes a second sloped surface 45b inclined toward the second end 7b, and the second sloped surface 45b and an inner circumferential surface 45c define the acute-angle portion 45a. Here, while the acute-angle portion 45a of the inner circumferential surface 45c on the side of the second end 7b is in contact with the outer circumferential surface of the rod 5, the inner circumferential surface 45c has an inner diameter gradually increasing toward the first end 7a so as to be inclined, thus being gradually spaced from the outer circumferential surface of the rod 5.

The first sloped surface 44a of the dust wiper 44 and the second sloped surface 45b of the scraper 45 have generally the same length and generally the same inclination with respect to the axial line in a cross-sectional view, when fitted in the third fitting groove 46.

In this embodiment, the third fitting groove 46 is open not only in the inner circumferential surface of the through hole 6 but also in the second end 7b of the rod cover 7, and includes a major diameter portion 46b having an opening 46a in the second end 7b and a minor diameter portion 46c extending from the major diameter portion 46b toward the first end 7a. The dust wiper 44 and the fixing ring 34 that retains the dust wiper 44 are accommodated in the major diameter portion 46b through the opening 46a, and the scraper 45 is accommodated in the minor diameter portion 46c.

To be more detailed, the dust wiper 44 is fixed in the major diameter portion 46b of the third fitting groove 46 by being abutted by the fixing ring 34 from the side of the second end 7b. In addition, as stated above, the first sloped surface 44a of the dust wiper 44 and the second sloped surface 45b of the scraper 45 have generally the same length and generally the same inclination with respect to the axial line in a cross-sectional view, the entire surface of the scraper 45 oriented to the second end 7b inclusive of the second sloped surface 45b is in close contact with the surface of the dust wiper 44 oriented to the first end 7a inclusive of the first sloped surface 44a.

Here, the fixing ring 34 is attached to the major diameter portion 46b through the opening 46a so as to be removed in the axial direction, so that upon removing the fixing ring 34 the dust wiper 44 can be replaced through the opening 46a.

In the major diameter portion 46b, as in the third embodiment, the inner circumferential portion of the dust wiper 44 communicates with the atmosphere through the gap between the outer circumferential surface of the rod 5 and the inner circumferential surface of the fixing ring 34, and through the opening 12. The major diameter portion 46b has an axial length that is equal to or slightly shorter than the total axial length of the dust wiper 44 and the fixing ring 34.

In addition, the minor diameter portion 46c has generally the same diameter as the outer diameter of the scraper 45, and generally the same axial length as that of the outer circumferential surface of the scraper 45. The scraper 45 is fixed to the minor diameter portion 46c with the outer circumferential surface thereof disposed in close contact with the inner circumferential surface of the minor diameter portion 46c, and the surface thereof oriented to the first end 7a disposed in close contact with the sidewall of the minor diameter portion 46c.

Thus, in the air cylinder 40 according to this embodiment the scraper 45 is attached to the surface of the dust wiper 44 oriented to the first end 7a such that the opposing surfaces thereof including the sloped surfaces 44a, 45b are in close contact with each other, and therefore even foreign substances firmly stuck to the outer circumferential surface of the rod 5 can be scraped off by the scraper 45, and the foreign substances thus scraped off can be entrapped in the dust wiper 44. Further, the foreign substances scraped off or entrapped by the dust wiper 44 can be more securely prevented from intruding inside the air cylinder 40 beyond the dust wiper 44.

Although some embodiments of the air cylinder according to the present invention have been described in details, it is to be understood that the present invention is in no way limited to those embodiments, but may be modified in various manners within the scope of the present invention. For example, applying a surface treatment to the outer circumferential surface of the rod 5 to prevent foreign substances from sticking thereto enhances the aforementioned advantageous effects.

1. An air cylinder comprising:
a piston that reciprocates in an axial direction of a cylinder chamber by supply and discharge of compressed air;
a rod attached to the piston so as to extend in the axial direction and to reciprocate together with the piston;
a rod cover provided on an end portion of the cylinder chamber in the axial direction and including a through hole that slidably supports the rod penetrating therethrough; and
an annular seal member provided in the through hole so as to air-tightly and slidably contact the rod,
wherein the rod cover includes a first end and a second end in the axial direction, the first end being located on the side of the cylinder chamber and the second end being located opposite the first end, and the through hole is formed through the rod cover between the first end and the second end;
the through hole includes an annular lubricator impregnated with a lubricant so as to supply the lubricant to the rod and a liquid-absorptive annular dust wiper not containing a lubricant and provided for preventing a foreign substance stuck to the rod from intruding into the first end side, the lubricator and the dust wiper being disposed slidably in contact with the rod;
the lubricator is located closer to the second end than the seal member is; and
the dust wiper is located closer to the second end than the lubricator is.

2. The air cylinder according to claim 1,
wherein the lubricator and the dust wiper are spaced from each other in the axial direction by an interval shorter than a stroke length of the piston.

3. The air cylinder according to claim 1,
wherein the dust wiper is located close to an opening formed in the second end of the through hole.

4. The air cylinder according to claim 1,
wherein the dust wiper is formed of a dry porous material having flexibility and compressibility in which inner pores communicate with each other.

5. The air cylinder according to claim 4,
wherein the dust wiper is larger in volume than the lubricator.

6. The air cylinder according to claim 4,
wherein the porous material is an aggregate fibrous material formed by combining fibers together.

7. The air cylinder according to claim 1,
wherein the dust wiper is breathable; and
the through hole includes an air inlet for air purge formed between the dust wiper and the lubricator.

8. The air cylinder according to claim 1,
wherein a non-porous annular scraper is provided adjacent to the dust wiper on the side of the first end so as to slidably contact the rod; and
a surface of the scraper oriented to the second end and a surface of the dust wiper oriented to the first end are in close contact with each other.

9. The air cylinder according to claim 8,
wherein the scraper includes an acute-angle portion directed to the second end, such that the scraper is in contact with the rod via the acute-angle portion.

10. The air cylinder according to claim 1,
wherein a fitting groove accommodating therein the dust wiper is formed on an inner circumferential surface of the through hole so as to open at the second end of the rod cover;
the dust wiper is fixed in the fitting groove by accommodating the dust wiper into the fitting groove through the opening thereof at the second end and making the fixing member abut on the dust wiper from the second end side; and
the fixing member is detachably attached to the fitting groove in the axial direction, so that the dust wiper can be replaced through the opening at the second end by detaching and attaching the fixing member.

11. The air cylinder according to claim 2,
wherein the dust wiper is located close to an opening formed in the second end of the through hole.

12. The air cylinder according to claim 5,
wherein the porous material is an aggregate fibrous material formed by combining fibers together.
